(19) United States
(12) Patent Application Publication
(10) Pub. No.: US 2008/0092337 A1
(43) Pub. Date: Apr. 24, 2008

(54) Ergonomic handle

(76) Inventor: James R. Gross, Richmond, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/521,370

(22) Filed: Sep. 15, 2006

(51) Int. Cl. B25G 1/10; B25G 1/00

(52) U.S. Cl. 16/430; 81/489

(57) ABSTRACT

An ergonomic tool handle is disclosed, for applications including surgical hand tools. The tool handle includes a body centered about a rotational axis and having opposite end portions. The body includes an outer gripping surface between the end portions. The outer gripping surface is defined by three contoured side surfaces having a convex radial and longitudinal shape with respect to the rotational axis. The body defines a longitudinal cross-section bounded by the three contoured side surfaces, the cross-section being shaped substantially as a circular triangle having three rounded apices.

### FIELD OF THE INVENTION

The present invention relates generally to handles on tools. More particularly, the present invention relates to an ergonomic handle for a tool.

### BACKGROUND OF THE INVENTION

Tool handles can be broadly divided into the Tee shape or the axial shape. The axial shape usually aligns with the axis of the tool or the axis about which the work is performed. Handles of the axial or cylindrical shape are often extensions of a tool that must be rotated during the performance of its task.

A typical rotational task is one of driving a threaded screw into a substrate. The handle is rotated, twisting the tool shaft and turning the fastener in the desired direction. When fasteners are driven with a hand tool they typically manifest increasing resistance to rotation as they penetrate the substrate. This resistance to turning may cause the tool handle to slip in the hand. The typical response to this condition is to increase hand pressure on the handle. This extra exertion of the hand muscles redirects both the attention of the tool user and the effort of the users hand away from the task and back to the handle grip. Furthermore, the hand fatigues more rapidly further suffering the task.

Most handle designs and configurations known in the art are not shaped to properly conform to the human hand or augment the tool's use or purpose. The known tool handles instead follow a historic lineage of geometric shapes with slight variation and color changes. The variety of handle designs available today would indicate that the hand must adapt to the handle shape rather than the handle conforming to the hand shape.

Most of the handle shapes considered state-of-the-art at this time can be classified as circular or close to circular when viewed in cross section. When the hand grips these shapes the fleshy pads of the fingers fill the space between the finger bones and the handle. In no instance does the bony architecture of the hand interact with a similar plane or the handle. As a result, the only resistance to inadvertent rotation or shear of the handle in the hand is the tension applied to the handle, through the flesh of the fingers, by the pressure of the hand.

The greater the handle resistance to rotation, the greater the pressure the hand must apply to the handle. This is fatiguing to the hand and subtractive to the task.

Handles on tools that are used in certain medical procedures such as orthopedics require that the amount of attention devoted to the containment or control of a tool be minimal. Full attention must be focused on the performance of the task such as driving a screw into a bone or fastening a plate to a vertebra. The tool must perform as an extension to the hand not a hindrance.

Examples of prior art handle designs are shown in U.S. Pat. No. 6,148,701 and No. 5,551,323. U.S. Pat. No. 5,551,323 shows a handle that is relatively of square cross-section. However a square cross-section fails to properly conform to the human hand and fails to adequately transfer the grip force vectors from the hand through the handle and ultimately to the object to be rotated or actuated by the tool. U.S. Pat. No. 6,148,701 shows a three-sided tool handle that is an improvement on the handle shown in U.S. Pat. No. 5,551,323. U.S. Pat. No. 6,148,701 further includes a handle that twists along its longitudinal length, so as to better conform to the grip of a human hand. However this patent shows a triangular cross-section that is relatively flat and not rounded, which again fails to properly conform to the grip force vectors for a human hand. A further prior art design Pat. No. D523,724 shows a three-sided tool handle with a cross-section that is made of three lobed protrusions. While the lobes may serve to provide some traction with the human hand grip, the entire shape of the handle in D523,724 does not lend itself to an adequate application of grip force, furthermore, when viewed in cross-section the handle is virtually round and by itself cannot prevent inadvertent rotation in the hand. Only extreme hand pressure can improve the grip on a round tool handle.

An ergonomic tool handle will conform to the bone under-structure (boney architecture) of the hand, forming a natural fit between bones, flesh and the tool handle. In this a manner an ergonomic or natural fit is created between the hand and the handle that prohibits the handle from rotating in the hand unless the hand is opened to release the handle.

Accordingly, it is desirable to provide a device that comfortably conforms to the human anatomy and permits more user attention and strength to be dedicated to the task or intended purpose of the tool rather than first holding the handle and then performing the task.

### SUMMARY OF THE INVENTION

The foregoing needs are met, to a great extent, by the present invention, wherein in one aspect an apparatus is provided that in some embodiments provides for an ergonomic too handle to better conform to the human grip, providing both the capability for enhanced precision and power through a uniquely shaped and contoured gripping configuration defined by the intersection of three side surfaces to substantially form a circular or Realeaux triangle in cross-section.

In accordance with one aspect of the present invention, an ergonomic tool handle is provided, having a body defining a central axis and having a distal end portion and a proximal end portion. The body includes three contoured side surfaces radially offset from the central axis and extending from the proximal end portion to the distal end portion. The three contoured side surfaces define a cross-section for the body shaped substantially as a Reuleaux triangle centered on the central axis.

In accordance with another aspect of the present invention, an ergonomic tool handle includes a body centered about a rotational axis having opposite proximal and distal end portions. The body includes an outer gripping surface between the end portions defined by three contoured side surfaces having a convex radial and longitudinal shape with respect to the rotational axis. The body defines a longitudinal cross-section bounded by the three contoured side surfaces and shaped substantially as a circular triangle having three apices.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side longitudinal view illustrating an ergonomic handle for a hand tool according to a preferred embodiment of the invention.

FIG. 2 is a plan view from the proximal end portion of the ergonomic handle shown in FIG. 1.

FIG. 3 shows an example of a Reuleaux triangle.

### DETAILED DESCRIPTION

The invention will now be described with reference to the drawing figures, in which like reference numerals refer to like parts throughout. An embodiment in accordance with the present invention provides an ergonomic tool handle to provide an improved gripping surface so as to transmit greater power and precision from the human hand actuating the handle to the object being actuated by the tool. The present invention includes a tool handle having a uniquely shaped and contoured gripping surface defined by the intersection of three side surfaces to substantially form a circular or Reuleaux triangle in at least one cross-sectional area along the longitudinal span of the handle. The crux of the present invention is that the tool handle comfortably conforms to the human anatomy and permits more user attention and strength to be dedicated to actuating an object with the handle, rather than to the holding of the handle itself.

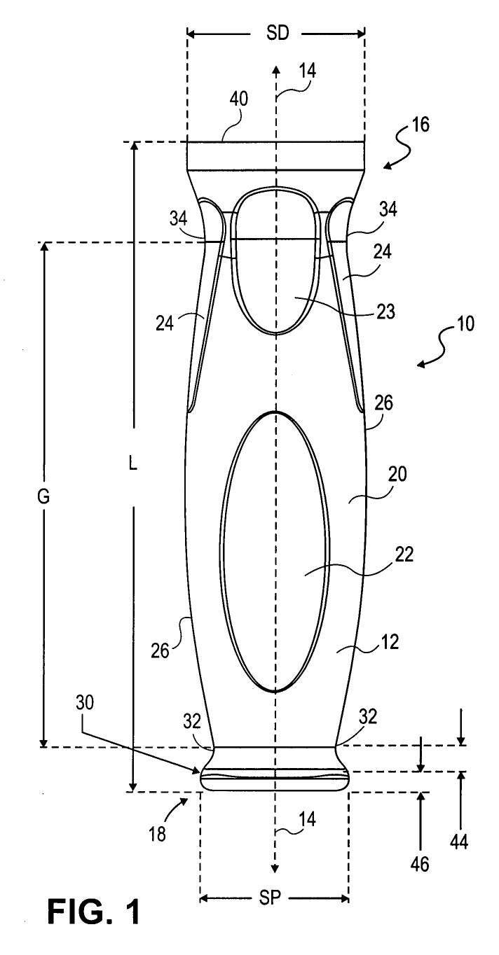

An embodiment of the present inventive apparatus is illustrated in FIG. 1. FIG. 1 is a side longitudinal view illustrating an ergonomic handle 10 for a hand tool according to a preferred embodiment of the invention. The handle 10 includes a body 12 defining a longitudinal central axis 14. The axis 14 is substantially centered along a longitudinal axis of rotation for the body 12. The handle body 12 defines distal end portion 16 and a proximal end portion 18. A shaft (not shown) can extend from the distal end portion 16 to an operative end of the tool (not shown) which can be used to actuate an object such as a screw. Additional sub-assemblies for actuating objects, such as a ratchet mechanism and other devices well-known in the art, can be coupled to the distal end portion 16.

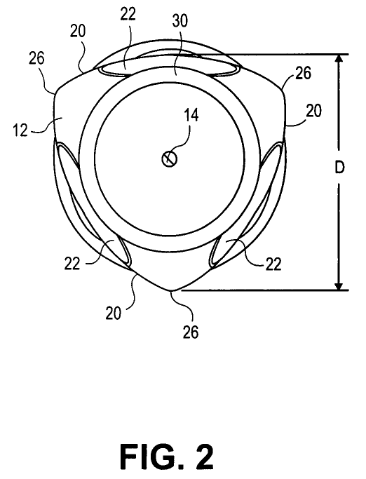

FIG. 2 is a plan view from the proximal end portion 18 of the ergonomic handle 10 shown in FIG. 1. The body 12 defines three contoured side surfaces 20 radially offset from the central axis 14 (shown as cross X within a circle in FIG. 2). The side surfaces 20 are contoured and extend from the proximal end portion 18 to the distal end portion 16. Within a central portion of each side surface 20, there is a depression 22, which depression 22 is positioned more closely to the proximal end portion 18 rather than the distal end portion 16. An additional set of depressions 23 are defined proximate the distal end portion 16 along the contoured side surfaces 20. A further set of depressions 24 are defined proximate the distal end portion 16 along a portion of the longitudinal edges 26 which are formed at the intersection of any two of the side surfaces 20. As shown in FIG. 2, the three contoured side surfaces 20 intersect to define three longitudinal edges 26. The edges 26 can each define the apex of a cross-sectional shape for the body 12. These points can be the apices of a cross-sectional shape which can generally be described to fit inside the outline of a circular triangle. As can be further seen in FIG. 2, the three contoured side surfaces 20 together define at least one cross-section for the body shaped substantially as a circular triangle centered on the central axis 14.

As is well-known in the art, and as further used herein, a “circular triangle” is a shape made of three circular arcs which together form the perimeter of a closed shape, which can resemble a triangle in the broadest sense. In mathematical terms, if the three circular arcs are identical to each other, a Reuleaux triangle is formed, which is a polygon that is a curve of constant width—that is, a curve in which all diameters are the same length. The Reuleaux triangle is named after Franz Reuleaux, a 19th-century German engineer. The Reuleaux triangle is the simplest nontrivial example of a curve of constant width—a curve in which the distance between two opposite parallel tangent lines to its boundary is the same, regardless of the direction of those two parallel lines. The trivial example would be a circle.

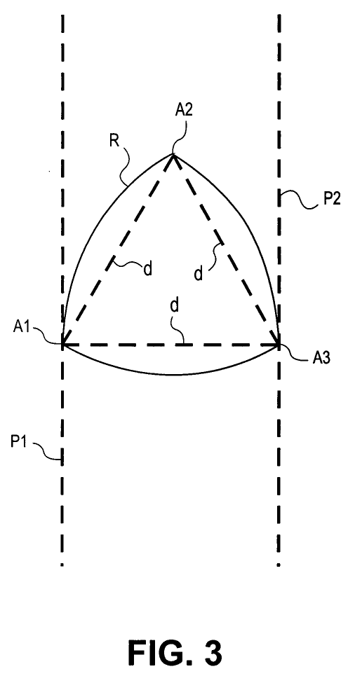

FIG. 3 shows an example of a Reuleaux triangle “R” having a diameter “d” which also forms the sides of an equilateral triangle circumscribed by the Reuleaux triangle R. The “width” of the Reuleaux triangle R is defined by two parallel lines P1 and P2 which have the same separation distance d regardless of their orientation when enclosing the Reuleaux triangle R. The Reuleaux triangle R is traced out by circular arcs having radius d centered on each of the apices A1, A2, and A3 of the Reuleaux triangle R. As shown in FIG. 2, at least some portion of the body 12 has a longitudinal cross-sectional shape (i.e. a cross-section perpendicular to the central axis 14) which broadly approximates a Reuleaux triangle. The width of the body across such a cross-section is labeled as D in FIG. 2.

Turning back to FIG. 1, the body 12 can also have an overall length L. In a preferred embodiment, the width D of the body 12 can be 1.435 inches, and the length L can be 5.050 inches. Such dimensions however are only exemplary, and can be altered depending on the shape of the handle desired and the size of the human hand intended to grip the handle. The ratio of the length L over the width D can be within a range of 3.3 to 3.7. In an exemplary embodiment, said ratio can be approximately equal to 3.5.

The body 12 also defines a radial lip 30 defined on the proximal end portion 18, thereby forming and defining a first neck 32 proximate the proximal end portion 18 between the radial lip 30 and the three contoured side surfaces 20. The body 12 and contoured side surfaces 20 can also each define a second neck 34 proximate the distal end portion 16. The first neck 32 and second neck 34 can define a grip length “G” which can vary according to the size of the hand. However a ratio of the grip length G over the body width D can be in the range of 2.5 to 2.9. In an exemplary embodiment, said ratio can be approximately equal to 2.7. Furthermore, the distal end portion 16 of the body 12 can span a distal end surface 40 which can have a width “SD” as shown in FIG. 1. In an exemplary embodiment, said width SD can be approximately equal to 1.440 inches. The proximal end portion 18 can also span a proximal end surface 42 which can have a width “SP” as shown in FIG. 1. In an exemplary embodiment, said width SP can be approximately equal to 1.125 inches. In an exemplary embodiment, the radius of curvature of lip 30 can be approximately equal to 0.1 inches, while the proximal half-span 44 of neck 32 in longitudinal direction can, in an exemplary embodiment, can be approximately equal to 0.2 inches. In the same exemplary embodiment, the thickness 46 of the lip can be approximately equal to 0.150 inches.

Due to its unique shape, the configuration of the handle 12 conforms to the anatomical architecture of the human hand. It provides for the various grip positions which can be commonly labeled as the “precision” grip and the “power” grip. In the “precision” grip, the pulp surfaces of the thumb and fingers are placed opposite each other. The fingers are flexed at the metacarpophalangeal joints, where the thumb extends straight from the hand. In a “power” grip, the combined fingers form one jaw of the clamp with the palm as the other jaw, where the thumb is curled around the handle with the tip of the thumb facing the fingertips. The tool handle of the present invention provides an arch defined by one of longitudinal edges 26 for the fingers to fold over, and flat land area largely defined by the surface of contoured side surfaces 20 and central depressions 22 for the ball of the thumb (also known as the Thenar muscle), providing the most anatomical anti-slip grip. The three side surfaces 20 that form the three sides of the handle triangle provide a surface to accommodate the thumb muscle and palm. The hand does not have to squeeze the handle 10 to prevent rotation of the handle relative to the hand. Instead the hand bones conform to the handle shape. This reduces hand fatigue and provides a user more energy for utilizing the handle and tool attached thereto.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An ergonomic tool handle comprising:
a body defining a central axis and having a distal end portion and a proximal end portion;
the body having three contoured side surfaces radially offset from the central axis and extending from the proximal end portion to the distal end portion;
the three contoured side surfaces defining a cross-section for the body shaped substantially as a Reuleaux triangle centered on the central axis.

2. The ergonomic tool handle of claim 1,
wherein the three contoured side surfaces intersect to define three longitudinal edges defining the apices of a plurality of cross-sections for the body,
wherein the body defines a depression proximate the distal end portion along a portion of at least one of the three longitudinal edges.

3. The ergonomic tool handle of claim 1,
wherein at least one of the three contoured side surfaces defines a depression proximate the distal end portion.

4. The ergonomic tool handle of claim 3,
wherein the depression is adapted to receive the thumb of a user when applying a precision grip to the tool handle.

5. The ergonomic tool handle of claim 1,
wherein at least one of the three contoured side surfaces defines a depression along a central portion proximate the proximal end portion.

6. The ergonomic tool handle of claim 1,
wherein the body has a body length and a body width, and
wherein a ratio of the body length over the body width is in the range of 3.3 to 3.7.

7. The ergonomic tool handle of claim 6,
wherein the ratio of the body length over the body width is substantially equal to 3.5.

8. The ergonomic tool handle of claim 1, further comprising:
a radial lip defined on the proximal end portion, defining a first neck proximate the proximal end portion between the radial lip and the three contoured side surfaces,
wherein the contoured side surfaces each define a depression proximate the distal end portion, to define a second neck proximate the distal end portion.

9. The ergonomic tool handle of claim 8,
wherein the first neck and second neck define a grip length, and the body defines a body width, and
wherein a ratio of the grip length over the body width is in the range of 2.5 to 2.9.

10. The ergonomic tool handle of claim 9,
wherein the ratio of the grip length over the body width is substantially equal to 2.7.

11. An ergonomic tool handle comprising:
a body centered about a rotational axis and having opposite proximal and distal end portions;
the body having an outer gripping surface between the end portions, the outer gripping surface being defined by three contoured side surfaces having a convex radial and longitudinal shape with respect to the rotational axis;
the body defining a longitudinal cross-section bounded by the three contoured side surfaces, the cross-section being shaped substantially as a circular triangle having three apices.

12. The ergonomic tool handle of claim 11,
wherein the three contoured side surfaces intersect to define three longitudinal edges defining the apices,
wherein the body defines a depression proximate the distal end portion along a portion of at least one of the three longitudinal edges.

13. The ergonomic tool handle of claim 11,
wherein at least one of the three contoured side surfaces defines a depression proximate the distal end portion.

14. The ergonomic tool handle of claim 13,
wherein the depression is adapted to receive the thumb of a user when applying a precision grip to the tool handle.

15. The ergonomic tool handle of claim 11,
wherein at least one of the three contoured side surfaces defines a depression along a central portion of the contoured side surface proximate the proximal end portion.

16. The ergonomic tool handle of claim 11,
wherein the body has a body length and a body width, and
wherein a ratio of the body length over the body width is in the range of 3.3 to 3.7.

17. The ergonomic tool handle of claim 16,
wherein the ratio of the body length over the body width is substantially equal to 3.5.

18. The ergonomic tool handle of claim 11, further comprising:
a radial lip defined on the proximal end portion, defining a first neck proximate the proximal end portion between the radial lip and the three contoured side surfaces,
wherein the contoured side surfaces each define a depression proximate the distal end portion, to define a second neck proximate the distal end portion.

19. The ergonomic tool handle of claim 18,
wherein the first neck and second neck define a grip length, and the body defines a body width, and
wherein a ratio of the grip length over the body width is in the range of 2.5 to 2.9.

20. The ergonomic tool handle of claim 19,
wherein the ratio of the grip length over the body width is substantially equal to 2.7.
